(19) United States
(12) Patent Application Publication
(10) Pub. No.: US 2008/0221969 A1
(43) Pub. Date: Sep. 11, 2008

(54) Method And System For Measuring And Ranking A "Thought" Response To Audiovisual Or Interactive Media, Products Or Activities Using Physiological Signals

(75) Inventors: Hans C. Lee, Carmel, CA (US); Timmie T. Hong, San-Diego, CA (US); William H. Williams, Hilo, HI (US); Michael R. Fettiplace, Madison, WI (US); Michael J. Lee, Carmel, CA (US)

Correspondence Address: PERKINS COIE LLP, P.O. BOX 1208, SEATTLE, WA, 98111-1208, US

(73) Assignee: EmSense Corporation, Monterey, CA (US)

(21) Appl. No.: 11/835,634

(22) Filed: Aug. 8, 2007

Related U.S. Application Data
(60) Provisional application No. 60/905,182, filed on Mar. 7, 2007.

(51) Int. Cl. G06F 17/30

(52) U.S. Cl. 705/10

(57) ABSTRACT

A system and method for calculating an objective thought value by contrasting alpha suppression and theta activation in response to stimulus by a media can be used to compare media based on an individual or a group of individuals. Events of the media can be contrasted and compared by the thought value as well. Statistical measurements may be taken to improve media.

### RELATED APPLICATIONS

This application claims priority to U.S. Provisional Patent Application No. 60/905,182, filed Mar. 7, 2007, and entitled “Method and system for measuring and ranking ‘thought’ response to audiovisual or interactive media, products or activities using physiological signals” by Hans C. Lee, et. al., which is incorporated herein by reference.

### BACKGROUND

Creative people design interactive media, activities and products (“media”) that stimulate individuals to think. Often times media are sold to consumers in highly competitive markets where the ability to stimulate thought determines value. The creative people would like to know whether thought is stimulated in order to maximize value by improving media to better stimulate individuals. If the value of the media is not maximized customers will purchase competing products which provide better stimulation. If competing products are sold, revenue will be lost as sales decline. A problem then is in providing accurate information about a response to stimulation by interactive media, activities, and products. Measuring the response requires creators of interactive media, activities and products to enter the minds of the target market.

In entering the human mind Researchers in Neurobiology, Psychophysiology, and Psychology found physiological signals emanating from the brain. Using the Electroencephalogram (EEG) researchers recorded the physiological signals though electrodes attached to the head. The physiological signals had four main components below 30 hertz. Frequencies between 1-4 hertz were delta waves (δ), frequencies between 4 and 8 hertz were theta (θ) waves, frequencies between 8-13 hertz were alpha (α) brainwaves, and frequencies between 13 and 20 were beta (β) brainwaves. Researchers studied the mind using the EEG; however, a system and method for measuring and ranking a thought response was not made available. The amount that media stimulates individuals to think was still unknown.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A novel technique measures a “thought” response of an individual to a media. The technique uses physiological signals emanating from the brain to gauge the thought response. A thought value is an objective measure of the thought response that contrasts alpha suppression with theta activation. Advantageously, the thought response can be used to efficiently improve media while it is being created. In a non limiting example, ranking determines whether the individual finds a television show more thought provoking than a documentary. Further, groups of individuals can have a thought response that can be measured and aggregated to determine the overall population response to the media. This population view of the media can then be used to rank the media which is a novel use of physiological changes in response to media.

### BRIEF DESCRIPTION OF THE DRAWINGS

FIG. 1 is an illustration of an example of a system 100 for calculating a thought value.

FIG. 2 depicts a flowchart 200 of an example of a method for calculating a thought value based on alpha suppression and theta activation.

FIG. 3 depicts a flowchart 300 of an example of ranking media based on thought values.

FIG. 4 depicts a diagram ranking a plurality of media based on the thought values assigned to the media.

FIG. 5 depicts a top view of a head of an individual.

FIG. 6 depicts a diagram of an example of stimulating an individual with a media while calculating a thought value.

FIG. 7 depicts a diagram of an example of stimulating a plurality of individuals with a media and calculating relevant thought values as stimulated by the media.

FIG. 8 depicts a diagram of an experiment in which an individual is instructed to think about different things and relevant thought values are recorded.

FIG. 9 depicts a diagram of an experiment in which an individual plays a game and thought values are aligned to events in time by identifying events at points in time at which the thought values were stimulated.

FIG. 10 depicts a headset containing electrodes useful for collecting signals from a head of an individual.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

A novel system and method for measuring a “thought” response to interactive media, products or activities uses physiological signals. An individual responds to a media while physiological sensors record this response. A processing component collects the physiological signals through the physiological sensors and substantially concurrently assigns a thought value to the amount the individual thinks. “Substantially concurrently” means that the response is at the same time or near in time to the stimulation. There may be a delay in the response. Therefore, the thought value is calculated with the understanding that the response may be immediately following if not exactly at the same time with the stimulation.

In some embodiments, an exemplary way of calculating a thought value is to contrast alpha suppression with theta activation using a mathematical formula using the physiological signals as inputs. Two useful physiological signals for calculating a thought value include alpha waves and theta waves. Other useful signals exist in the range of 1-100 Hz. When calculating a thought value, an increase in theta levels is indicative of thought whereas an increase in alpha levels is indicative non-thinking or mindlessness.

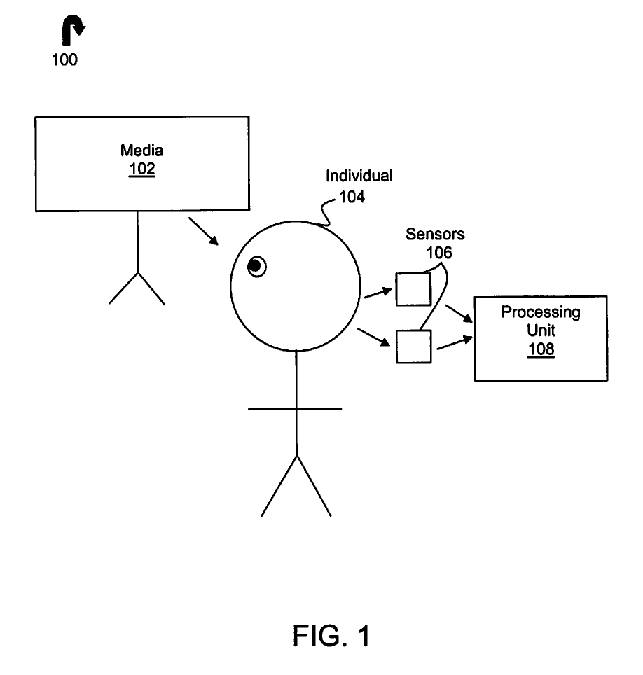

FIG. 1 is an illustration of an example of a system 100 for calculating a thought value. Although this illustration depicts components as functionally separate, such depiction is merely for illustrative purposes. Those skilled in the art know that the components portrayed in this figure can be arbitrarily combined or divided into separate software, firmware and/or hardware components. Furthermore, such components, regardless of how they are combined or divided, can execute on the same computing device or multiple computing devices, and wherein the multiple computing devices can be connected by one or more networks.

In the example of FIG. 1, the system 100 includes media 102, individual 104, sensors 106, and processing component 108. As depicted, individual 104 is stimulated by media 102 while having the individual's thought level is monitored by processing component 108 using sensors 106. Here the media can be one or more of a movie, a video a television program, a commercial, an advertisement, a video game, an interactive online media, a print, or any other media which could stimulate an individual. Sensors 106 could be one or more of an accelerometer, a blood oxygen sensor, a galvanometer, an electroencephalogram, an electromygraph, and any other physiological sensor.

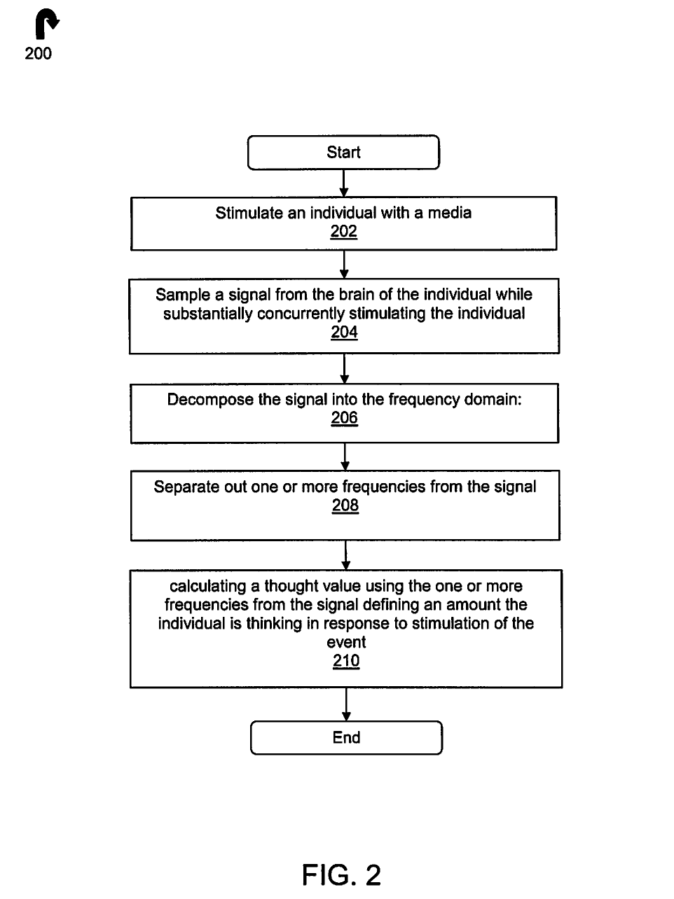

FIG. 2 depicts a flowchart 200 of an example of a method for calculating a thought value based on alpha suppression and theta activation. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 2, the flowchart starts at module 202 with stimulating an individual with a media. In exposing the individual to the media, the individual may interact or view the media such that the individual's mind is stimulated.

In the example of FIG. 2, the flowchart continues to module 204 with sampling a signal from a brain of the individual while substantially concurrently stimulating the individual.

In the example of FIG. 2, the flowchart continues to module 206 in which the signal is decomposed into the frequency domain to allow alpha and theta components of the signal to be separated from the signal for use in analysis. In this example, the Fast Fourier Transform (FFT), or wavelet analysis, are used for the decomposition. FFT is an efficient method of computing the Discrete Fourier Transform (DFT); DFT could be used as well as other methods of computing Fourier analysis. In the alternative, wavelet analysis could be used to divide the signal into its different frequency components so that they can be considered separately. Specifically, the Morlet wavelet or the Mexican hat wavelet would be useful for doing so. Additionally, the Daubechies wavelets, the Beta wavelets, and the Coiflet wavelets could be used. Further, other methods of digital signal processing could be substituted by one skilled in the art.

In the example of FIG. 2, the flowchart continues to module 208 in which frequencies are separated out from the signal. In a non-limiting example, alpha waves and theta waves are separated from the signal and stored into bins. In storing the frequencies from the signal, bins hold sampled signals from the frequency domain. A DFT bin can be defined by calculating an n point DFT. Specifically, n different sample values are created X(0) through X(n−1). With i being a value 0 to n−1, X(i) is a bin holding relevant sample values. The Alpha bin can hold anything between 8-13 hz, but not necessarily including all frequencies in that range. The Theta bin can hold anything between 4-8 hz, but does not have to include all frequencies. Similarly, delta and beta waves can be held in delta and beta bins. Additionally, the frequency profile can be adjusted to remove noise in the signal such as white noise or pink noise.

In the example of FIG. 2, the flowchart continues to module 210 which calculates a thought value using the one or more frequencies from the signal defining an amount the individual is thinking in response to stimulation of the event. This thought value can for be used for comparison with a reference value thereby rating the media based on the difference between the thought value and the reference value for the event of the media The presence of alpha waves or frequencies between 8 and 13 Hz are associated with a blank mind, and therefore suppression of alpha waves is associated with thinking. Theta activation refers to increasing levels of theta activity in the brain and is correlated with increased levels of thought.

In some embodiments it is possible to sense thought using only alpha, or only theta. Additionally the following examples are of formulas from which a single formula could be used to calculate a thought value, wherein z/EEG represents x in contrast to total EEG power. Further, an optimized multiplier of theta could be used, such as by taking the natural log of theta and multiplying by a scale factor. In a non-limiting example theta could be optimized as: optimized theta=s·In(theta) where s is a scale factor and In(x) represents a function finding the natural log of x. The following functions could be used to find a thought value. Theta or optimized theta could be used in conjunction therewith.

$$\frac{θ - α}{α - θ} \qquad \frac{2 θ - α}{2 α + θ} \qquad \frac{α - θ}{θ + α} \qquad \frac{α}{EEG} \qquad \frac{θ}{EEG}$$

These example formulas are intended to be non-limiting. A number of different formulas would work and one of these formulas could be modified in the spirit of these teachings to create a formula that would suit a specific application.

In some embodiments, one or more events of a media are used to define a thought value for the media. An event is an identifiable portion of a media. It could be the punch line of a joke, or an important scene of a movie. An event of a media is measurable and can have a thought value associated with it. A number of events will have a number of thought values. The media can be ranked as a whole by considering the events it contains and thought values associated with those events.

In some embodiments, a derivative may be calculated to determine a change in thought indicating a response to stimulus. In a non-limiting example an event of a media causes a person to think causing a positive thought response which is identified by a positive derivative. A positive derivative indicates an increase in thought and a negative derivative indicates a decrease in thought. Creators of media could use this information to create media which incites more thought, or less thought as the creators' desire.

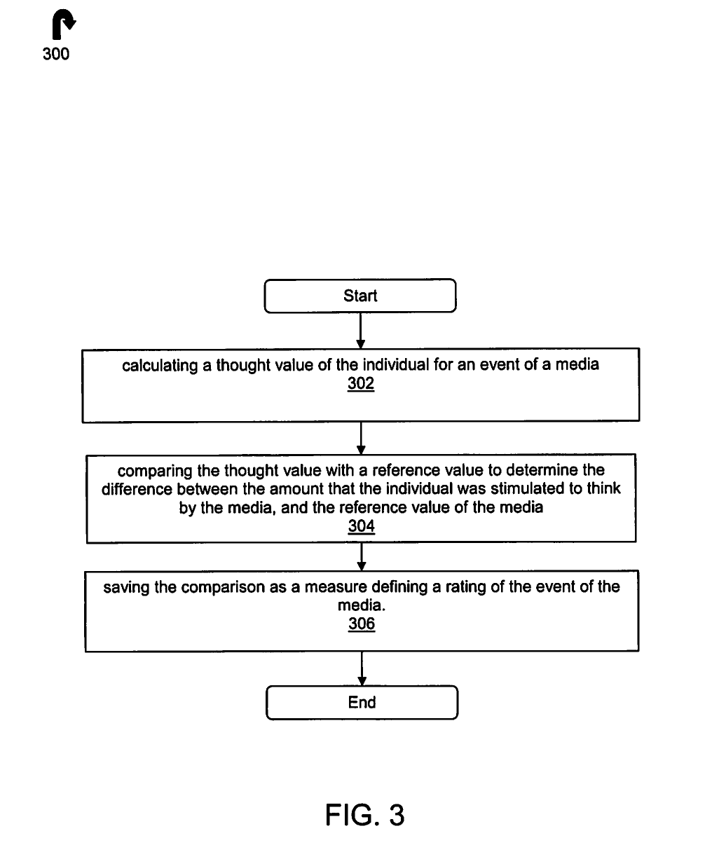

In some embodiments, a media may be ranked based on thought values. FIG. 3 depicts a flowchart 300 of an example of ranking media based on thought values. The method is organized as a sequence of modules in the flowchart 300. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

In the example of FIG. 3, the flowchart 300 starts at module 302 with calculating a thought value of the individual for an event of a media. This is completed as is discussed in reference to FIG. 2

In the example of FIG. 3 the flowchart there continues to module 304 with comparing the thought value with a reference value to determine the difference between the amount that the individual was stimulated to think by the media, and the reference value of the media. This is completed as is discussed with reference to FIG. 2. This second media could be any second media, and would not need to be the same kind of media as the first media. The thought response to the first media and the second media are objective values, and may be used with any kind of media.

In the example of FIG. 3 the flowchart continues to module 306 in saving the comparison as a measure defining a rating of the event of the media. In this way, as well as other ways described herein, media can be rated

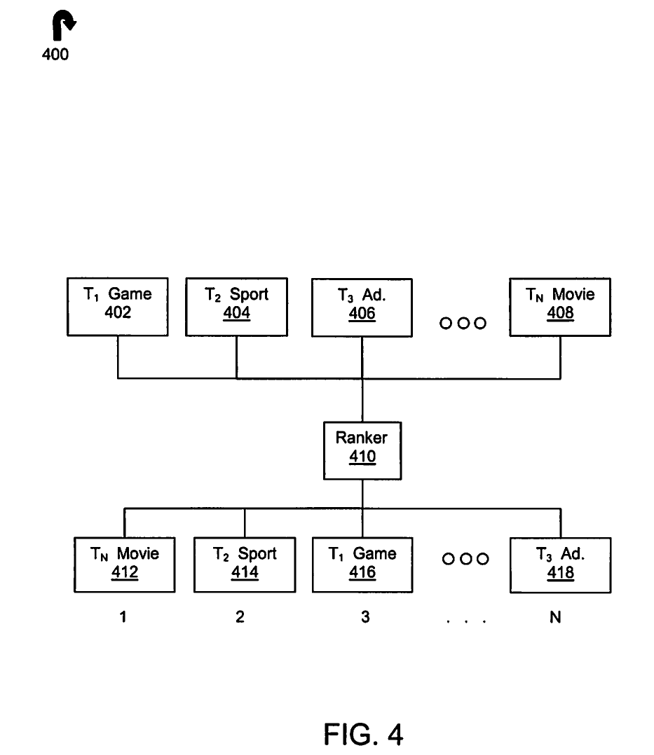

In some embodiments, a plurality of media is ranked according to thought values. FIG. 4 depicts a diagram 400 ranking a plurality of media based on the thought values assigned to the media. Diagram 400 includes game 402, sport 404, advertisement (ad.) 406, movie 408, ranker 410, ranked movie 412, ranked sport 414, ranked game 416, and ranked ad. 4018. In the example of FIG. 4, the unranked media game 402, sport 404, ad. 406, movie 408 are later ranked in order of their ability to provoke thought as related to alpha suppression and theta activation. A plurality of n different media could be ranked. The relative ranking of the n different media could be accomplished by comparison relative to an individual or a group as described in the discussion of FIG. 3. Different statistical measures could be used to define the ranking as it suits the individual application.

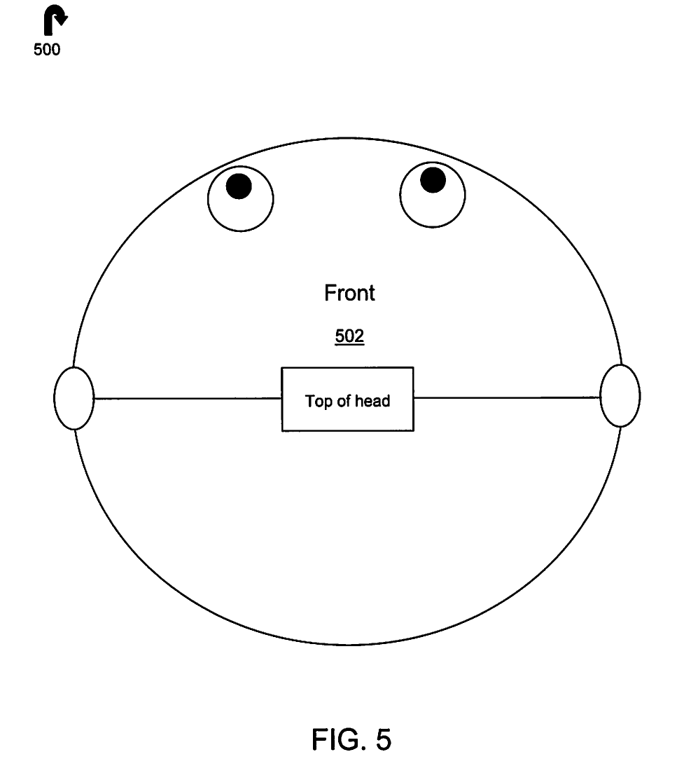

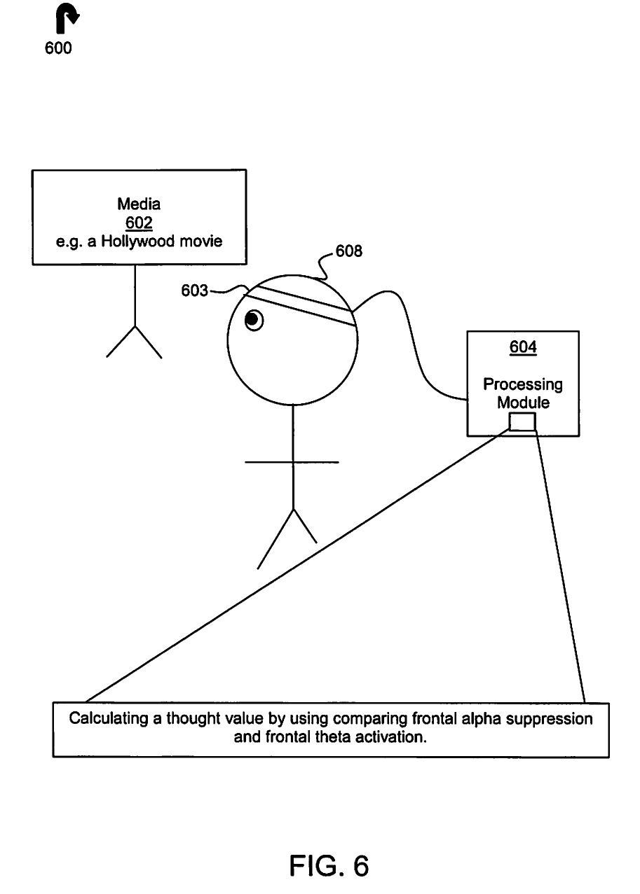

In some embodiments, frontal theta is used to calculate a thought value. In a non-limiting example a headset having frontal sensors could be used. FIG. 5 depicts a top view of a head 500 of an individual. Included in the head 500 is front 502. Frontal alpha and frontal theta from front 502 are relevant to specific implementations of formulas used to calculate the thought value. The frontal alpha and frontal theta are denoted θ_{F}, α_{F} respectively. An example of a formula which would consider frontal theta follows: (θ_{F}−α_{F})/(θ_{F}+α_{F}). Such a formula could be used to determine a thought value by contrasting frontal theta activation with frontal alpha suppression. FIG. 6 depicts a diagram 600 of using the headset to sample frontal alpha and frontal theta. Diagram 600 includes media 602, headset 603 processing component 604, and individual 608. As depicted, individual 608 watches media 602 while having his thought level monitored by the processing component 604. Frontal signals are collected from the front of the head via headset 603 and transmitted to processing component 604 for processing into thought value.

In some embodiments an aggregate of a number of individual thought values derived from physiological responses is created determining a group response to a media. The aggregation can be by an average response for the number of individuals or by a higher ordered approximation.

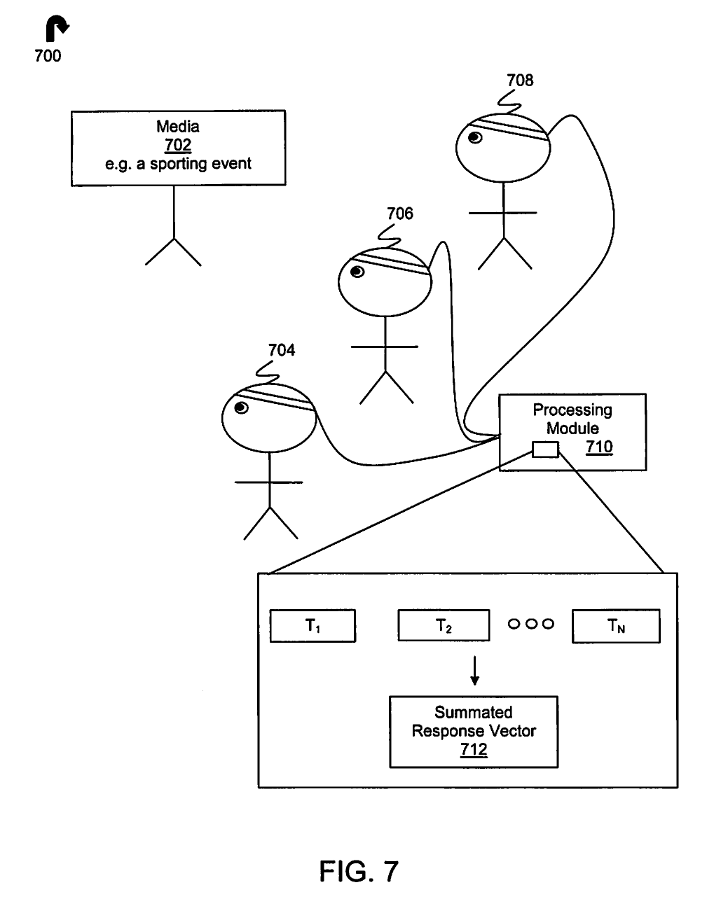

In some embodiments a plurality of individuals is sampled to produce a summated response vector which identifies the number of individuals which respond with thought to a stimulus. FIG. 7 depicts a diagram 700 of an example of stimulating a plurality of individuals with a media and calculating relevant thought values as stimulated by the media. Diagram 700 includes media 702, individuals 704, 706, 708, processing component 710, and summated response vector 712. Here, the plurality of individuals 704, 706, and 708 are stimulated by the media and the collective thoughts are analyzed based on alpha suppression and theta activation. The summated response vector, 712, can be used to determine the number of persons who responded such that a single value could be produced indicating the number of users that responded to the media with thought. This is a statistical value that could be generated to provide additional information about the thought provoking ability of a media.

In some embodiments, a thought value is aligned to a media by correlating an event occurring at a specific time to the thought value at that specific time. Aligning the thought values to the media provides useful information about the context of the thought values and why specific thought values are as high or low as they are. An individual response to the stimulus of a media may be broken down into events in time. In a non-limiting example a game could include an event identified as a referee signaling an erroneous foul. An individual having his thoughts monitored while watching the game could be monitored for an increase in thought while the individual wonders “why did the referee signal a foul?” By correlating the thought value with the media, stimulus can be linked to thought. Advantageously, this information can be used to improve the media by changing the media. In a non-limiting example, identifying and firing referees that signal erroneous fouls could be accomplished by noting which fouls receive the most thought.

In some embodiments, an event is classified as a specific type of event by using a mathematical transform to compare the event with other events. Such mathematical transforms may include but are not limited to, an average, a first order derivative, a second order derivative, a polynomial approximation, a standard deviation from the mean, a standard deviation of derivatives from the mean, and profiles of the physiological responses, which can be implemented with convolution or other methods that takes into account one or more of: peaking in the middle, spiking in the beginning, being flat, etc.

In some embodiments a reference value is used to compare a user thought response to an event with a predetermined thought value of the event. The reference value could be anything developed for the purpose of providing a comparison value from which to determine a difference between the user's thought value and the event. Developers of media may create their own reference values. A reference value may be an ideal value i.e. a goal desired. A reference value could be the average of a number of different user thought values calculated solely for the purpose of developing a reference value from which to compare other individuals.

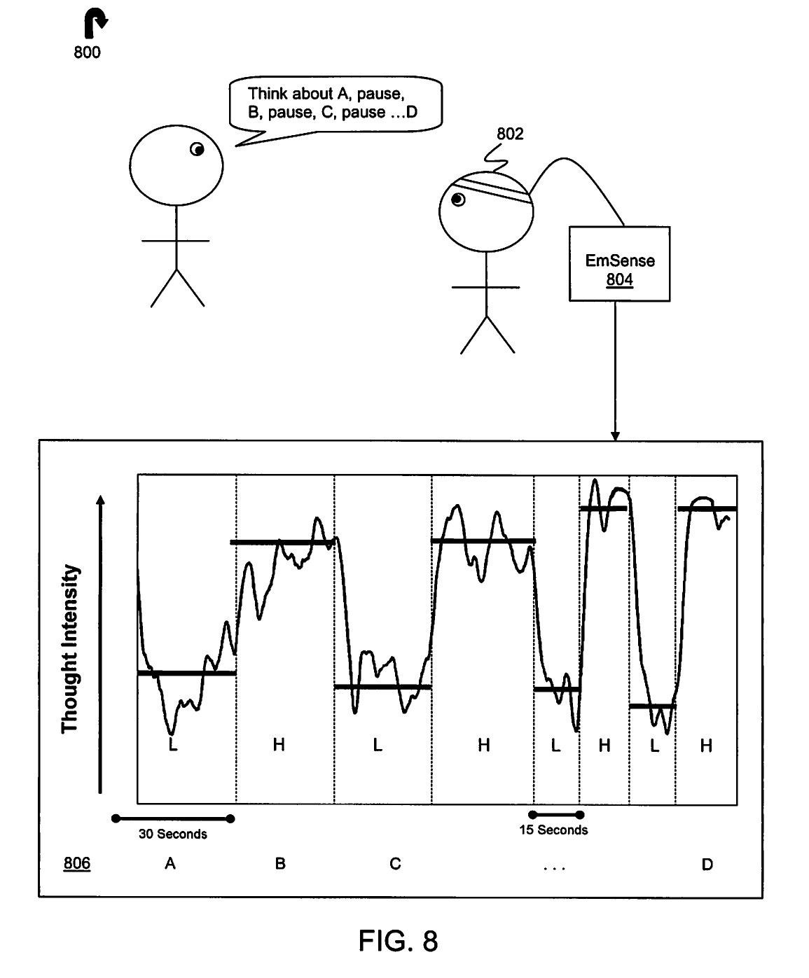

FIG. 8 depicts a diagram of an experiment 800 in which an individual is instructed to think about different things and relevant thought values are recorded and aligned to events. These recorded thoughts are then aligned to the media. Experiment 800 includes individual 802, processing component 804, and intensity graph 806. Here, the individual is asked to consider a plurality of different ideas, one after the other. As the individual thinks about the ideas his thoughts are collected and graphed as thought intensity relative to time in intensity graph 806. Various periods of time are marked A, B, C, and D, and these time periods are aligned with the plurality of ideas that the individual is asked to think about. Notably, certain portions of intensity graph 806 are significantly higher than other portions. High (H) and Low (L) periods of thought are aligned with different periods of time A though D.

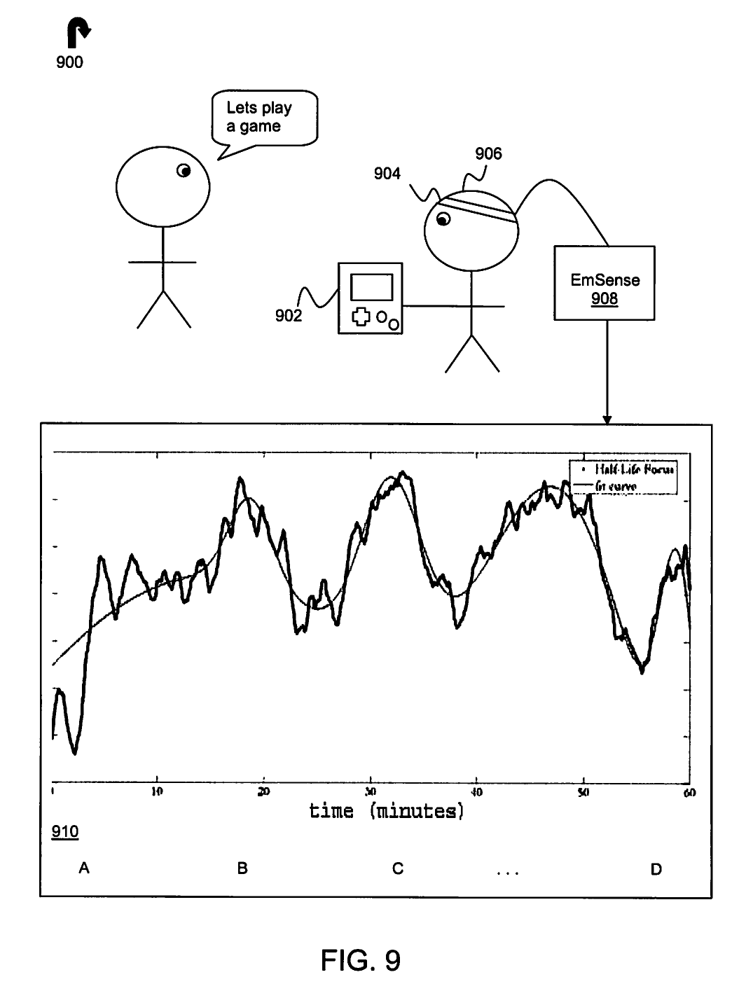

FIG. 9 depicts a diagram 900 of an experiment in which an individual plays a game and thought values are aligned to events in time by identifying events at points in time at which the thought values were stimulated. Diagram 900 includes game 902, headset 904, individual 906, processing component 908, and graph 910. In the example of FIG. 9, an individual is asked to play game 902 while processing component 908 records his brainwaves through headset 904 and calculates his level of thought by contrasting alpha suppression and theta activation. Variant levels of thought result and are displayed in graph 910 corresponding to different events in game 902. Time markers A, B, C, and D note sharply positive and negative changes in thought.

In some embodiments, an integrated headset can be placed on a viewer's head for measurement of his/her physiological data while the viewer is watching an event of the media. The data can be recorded in a program on a computer that allows viewers to interact with media while wearing the headset.

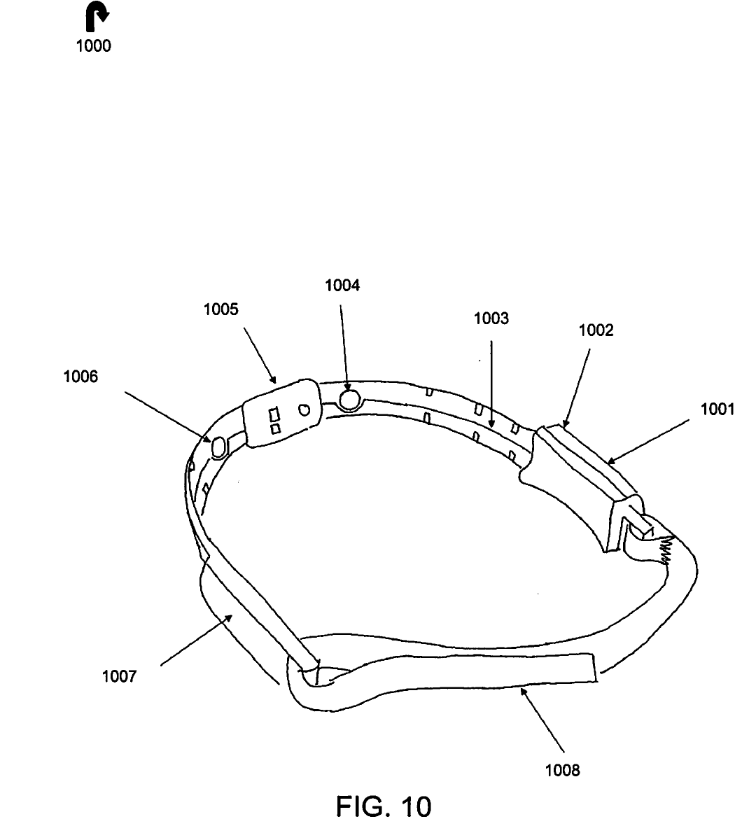

FIG. 10 depicts a headset 1000 useful for collecting signals from a head of an individual. Headset 1000 includes processing device 1001, three axis accelerometer 1102, silicon stabilization strip 1003, right EEG electrode 1004, heart rate sensor 1005, left EEG electrode 1006, battery module 1007, and adjustable strap 1008. Processing device 1001 is a microprocessor that digitizes physiological data and could process the data into physiological responses that include but are not limited to thought, engagement, immersion, physical engagement, valence, vigor and others. In a non-limiting embodiment, processing device 1001 is a processing component which calculates a thought value. Alternatively, a separate processing component connects to headset 1000 to calculate at thought value. A three axis accelerometer 1002 senses movement of the head. A silicon stabilization strip 1003 allows for more robust sensing through stabilization of the headset that minimizes movement. The right EEG electrode 1004 and left EEG electrode 1006 are prefrontal dry electrodes that do not need preparation to be used. Contact is needed between the electrodes and skin but without excessive pressure. The heart rate sensor 1005 is a robust blood volume pulse sensor positioned about the center of the forehead and a rechargeable or replaceable battery module 1007 is located over one of the ears. The adjustable strap 1008 in the rear is used to adjust the headset to a comfortable tension setting for many different head sizes.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations, and equivalents as fall within the true scope of the present invention.

We claim:

1. A method for sensing a thought response for use in rating media comprising:
stimulating the individual with a media containing an event;
sampling a signal from a brain of the individual while substantially concurrently stimulating the individual with the event of the media;
decomposing the signal into a frequency domain;
separating out one or more frequencies from the signal; and
calculating a thought value using the one or more frequencies from the signal defining an amount the individual is thinking in response to stimulation of the event for comparison with a reference value thereby rating the media based on the difference between the thought value and the reference value for the event of the media.

2. The method of claim 1 wherein only one frequency is selected from alpha and theta and only the one frequency is used to calculate the thought value.

3. The method of claim 1 wherein the thought value is associated with the event in the media.

4. The method of claim 1 wherein multiple thought values from multiple individuals associated with an event in the media are aggregated to form a thought response to the event.

5. The method of claim 1 wherein multiple thought values from multiple individuals are included in a summated response vector identifying the number of persons that responded with thought to the media.

6. The method of claim 1 wherein the thought value is calculated using a formula wherein the formula comprises (θ−α)/(θ+α), (2*θ−α)/(2*θ+α) (θ_{F}−α_{F})/(θ_{F}+α_{F}), (α/EEG), or (θ/EEG); and wherein θ_{F} designates frontal brain theta and αdesignates frontal brain alpha.

7. The method of claim 1 wherein the signal is decomposed using a fast fourier transform or a wavelet analysis.

8. The method of claim 7 wherein the wavelet analysis is accomplished using a wavelet selected from a mexican hat wavelet a morlet wavelet, a daubechies wavelet, a beta wavelet, and a coiflet wavelet.

9. The method of claim 1 further comprising calculating a derivative of the thought value to show a change in thought over time.

10. The method of claim 1 wherein the media is selected from television, video game, audiovisual advertisement, board game, card game, live action event, print advertisement, and web advertisement.

11. The method of claim 1 wherein the thought value corresponds to a point in time, and the thought value is aligned to the media by correlating the thought value with an event occurring at the point in time by identifying an event of the media which occurred substantially concurrently.

12. The method of claim 1 further comprising calculating a second thought value defining an amount the individual is thinking in response to stimulation by a second media.

13. A method for rating media based on the amount that an individual is stimulated to think comprising:
calculating a thought value of the individual for an event of a media;
comparing the thought value with a reference value to determine the difference between the amount that the individual was stimulated to think by the media, and the reference value of the media; and
saving the comparison as a measure defining a rating of the event of the media.

14. The method of claim 13 wherein the reference value is supplied by a developer of the media.

15. The method of claim 13 wherein the reference value is an average value of numerous previously calculated thought values of other individuals.

16. The method of claim 13 wherein the thought value is calculated using solely alpha or solely theta.

17. The method of claim 13 wherein the thought value is calculated using a formula wherein the formula comprises (θ−α)/(θ+α), (2*θ−α)/(2*θ+α), or (θ_{F}−α_{F})/(θ_{F}+α_{F}), (α/EEG), or (θ/EEG); and wherein θ_{F} designates frontal brain theta and α designates frontal brain alpha.

18. The method of claim 13 wherein the media is selected from television, video game, audiovisual advertisement, board game, card game, live action event, print advertisement, and web advertisement.

19. A program for sensing a thought response for use in rating media embodied in a computer readable medium that when executed cause a system to:
sample a signal from the individual stimulated by an event in a media;
decompose the signal into a frequency domain;
separate out one or more frequencies from the signal; and
calculate a thought value using the one or more frequencies from the signal defining an amount the individual is thinking in response to stimulation for comparison with other thought values in rating the media.

20. The program of claim 19 wherein only one frequency is selected from alpha and theta and only the one frequency is used to calculate the thought value.

21. The program of claim 19 wherein the thought value is associated with many events of the media.

22. The program of claim 19 wherein multiple thought values from multiple individuals associated with the event in the media are aggregated to form a thought response to an event.

23. The program of claim 19 wherein multiple thought values from multiple individuals are included in a summated response vector identifying the number of persons that responded with thought to the media.

24. The program of claim 19 wherein the event is classified as a specific type of event by using a mathematical transform to compare the event with other events.

25. The program of claim 19 wherein the thought value is calculated using a formula wherein the formula comprises (θ−α)/(θ+α), (2*θ−α)/(2*θ+α), or (θ_{F}−α_{F})/(θ_{F}+α_{F}), (α/EEG), or (θ/EEG); and wherein θ_{F} designates frontal brain theta and α designates frontal brain alpha.

26. The program of claim 19 wherein the signal is decomposed using a fast fourier transform or a wavelet analysis.

27. The program of claim 19 further comprising calculating a derivative of the thought value to show a change in thought over time.

28. The program of claim 19 wherein the signal is sampled in relation to the media selected from television, video game, audiovisual advertisement, board game, card game, live action event, print advertisement, and web advertisement.

29. The program of claim 19 wherein the signal is aligned relative to the media to create a first aligned thought value corresponding to a first event in time which can be compared with a second aligned thought value corresponding to a second event in time.

30. A system for sensing a thought response for use in rating media comprising:
one or more sensors operable to sample a first signal from the individual;
a processing component connected to the one or more sensors operable to:
sample a signal from the individual stimulated by an event of a media using the one or more sensors;
decompose a signal into a frequency domain;
separate out one or more frequencies from the signal; and
calculate a thought value using the one or more frequencies from the signal defining an amount the individual is thinking in response to stimulation of the event for comparison with a reference value thereby rating the media based on the difference between the thought value and the reference value for the event of the media.

31. The system of claim 30 wherein the one or more sensors are included in an integrated sensor headset operable to measure a signal from the individual stimulated by the media;

32. A system for sensing a thought response for use in rating media comprising:
means for sampling a signal from an individual stimulated by an event of a media;
means for decomposing a signal into a frequency domain;
means for separating out one or more frequencies from the signal; and
means for calculating a thought value using the one or more frequencies from the signal defining an amount the individual is thinking in response to stimulation of the event for comparison with a reference value thereby rating the media based on the difference between the thought value and the reference value for the event of the media.
